(19) United States
(12) Patent Application Publication
(10) Pub. No.: US 2006/0226051 A1
(43) Pub. Date: Oct. 12, 2006

(54) USE OF UREA-FORMALDEHYDE RESIN IN POTASH ORE FLOTATION

(75) Inventors: Joe Navarrette, Carlsbad, NM (US); Jim Johnson, Carlsbad, NM (US); Steve Gamble, Carlsbad, NM (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: The Mosaic Company, Plymouth, MN (US)

(21) Appl. No.: 11/279,065

(22) Filed: Apr. 7, 2006

Related U.S. Application Data
(60) Provisional application No. 60/669,280, filed on Apr. 7, 2005.

(51) Int. Cl. B03D 1/02; B03D 1/01

(52) U.S. Cl. 209/166; 209/167

(57) ABSTRACT

A potash ore processing method for the recovery of potassium minerals from potash ore can comprises conditioning a pulped potash ore, wherein the potash ore comprises a potassium chloride component and a clay component, in a saturated brine solution with an effective amount of brine dispersible urea-formaldehyde resin or modified brine dispersible urea-formaldehyde resin. In some embodiments, the processing method requires little or no frother and/or reduced amounts of flocculent while achieving potassium mineral recovery at least as good as the equivalent process without the urea-formaldehyde resin. In addition, the separation of clay waste from saturated brine for the reuse of the brine can be made more efficient through the use of urea-formaldehyde resin.

### FIELD OF THE INVENTION

The invention relates generally to the field of potash ore or sylvinite ore processing. More particularly, the present invention pertains to use of a flotation depressant and flocculation aid, urea-formaldehyde resin and derivatives of urea-formaldehyde resin, resulting in improved processing and improved muriate of potash yields from the sylvinite ore.

### BACKGROUND OF THE INVENTION

Muriate of potash or potassium chloride (KCl) is commonly used as a fertilizer and as an animal feed. The economic sources of muriate of potash generally occur in sedimentary salt beds, the evaporative deposits of ancient inland seas. There are a number of potassium-containing minerals that may be present in commercial potash deposits. The term potash generally refers to a variety of minerals containing potassium (K) and potassium content is generally expressed on a potassium oxide (K₂O) equivalent basis. Potassium-containing minerals that may be present in potash deposits include, for example, sylvite. Sylvite is the most abundant potassium mineral in commercial deposits. Sylvite and halite (NaCl) form sylvinite, which is a common potash ore. Potash ores can contain other minerals such as kieserite [MgSO₄.H₂O], CaSO₄, polyhalite [K₂SO₄.2MgSO₄.2CaSO₄.H₂O] and langbeinite [K₂SO₄.2MgSO₄]. For ease of discussion, as used herein, the term “potash ore” includes the various potassium-containing minerals, and the present invention is directed to the flocculation of clay minerals and to the floatation of potash ore and recovery of muriate of potash (KCl; potassium chloride).

### SUMMARY OF THE INVENTION

The invention relates to the use of urea-formaldehyde resin and derivatives of urea-formaldehyde resin in potash ore refining and the discovered process improvements. At predetermined levels, among other benefits, the urea-formaldehyde resin and derivatives of urea-formaldehyde resin reduce the amount of floatation collector reagent and clay flocculent incorporated in the potash ore processing at a particular yield, and generally improve the yields of KCl from the potash ore.

In a first aspect, the invention relates to a potash ore processing method for the recovery of potassium minerals from potash ore comprising conditioning a pulped potash ore and substantially separating the potassium mineral component by way of a floatation process. The potash ore comprises a potassium mineral component and a clay component. The conditioning is performed in a saturated brine solution with an effective amount of brine dispersible urea-formaldehyde resin and frother. The amount of frother used is less than used in an equivalent process which does not include a urea-formaldehyde resin. In addition, separating the potassium mineral component by way of the floatation process provides for recovery of at least as much potassium mineral as in the equivalent process which does not include urea-formaldehyde resin.

In a further aspect, the invention relates to a potash ore processing method for the recovery of potassium minerals from potash ore comprising contacting a pulped potash ore with a saturated brine solution with an effective amount of brine dispersible urea-formaldehyde resin, conditioning the clay component with flocculent and substantially separating the potassium mineral component by way of a floatation process. The potash ore comprises a potassium mineral component and a clay component. The amount of flocculent used is less than the amount of flocculent used in an equivalent process which does not include a urea-formaldehyde resin, in which the flocculent initiates agglomeration of the clay. Furthermore, the potassium mineral component recovered can be at least as much potassium mineral as in the equivalent process which does not include urea-formaldehyde resin.

In additional aspects, the invention relates to a potash ore processing method for the recovery of potassium mineral from potash ore comprising conditioning a pulped potash ore, conditioning the clay component with flocculent, substantially separating the potassium mineral component by way of a floatation process and separating the clay component of the potash ore from the brine. The potash ore comprises a potassium mineral component and a clay component. The conditioning of the pulped potash ore is performed in a saturated brine solution with an effective amount of brine dispersible urea-formaldehyde resin. In the conditioning the clay component with flocculent, clay agglomerates are formed in the brine after addition of the flocculent. Also, the separating of the clay component of the potash ore from the brine can be performed through settling of the clay component and/or separation of the process brine from the clay by way of a solids-liquid separation unit operation. The potential liquid removal rate is increased at least an average of about 10% (volume/hour) as compared to an equivalent process which does not include urea-formaldehyde resin.

### BRIEF DESCRIPTION OF THE FIGURES

FIG. 1 shows a chart of the use of flocculent to agglomerate the “mud” or slimes.

FIG. 2 shows a chart of the improvement in flow of “mud” or slimes.

FIG. 3 is a generic schematic diagram of an embodiment of the potash floatation refining process

FIG. 4 is a schematic diagram of one embodiment of the potash floatation refining process.

FIG. 5 is a schematic diagram of one embodiment of the potash floatation refining process.

FIG. 6 is a chart showing the increase in muriate of potash concentration production.

FIG. 7 is a chart showing reduction of potash in the slimes or “tails”.

FIG. 8 is a chart showing reduction of formerly unprocessable ore.

FIG. 9 shows Table 2, which shows the amount of recovery of KCl at various amounts of reagent usage.

FIG. 10 shows Table 4, which shows tests results of reagent usage and percent KCl recovery.

### DETAILED DESCRIPTION OF THE INVENTION

Potassium containing ore generally is referred to as potash ore. The potash ore contains the desired potassium minerals as well as impurities, which are to be removed. The potash ore can be crushed into finer particulate material if the initial ore does not have the desired fineness. The crushed potash ore is combined with brine for processing of the material. Removal of contaminants can be based on initial processing steps using mechanical agitation or with processes such as clay floatation, in which the desired materials are separated from certain impurities, such as clay. The separated clays are removed with some of the brine. The ore mixed with the brine can be passed through a sizing unit to separate particles by size. Larger particles may be subjected to further crushing before being combined with the initial fines for additional purification. One or more additional purification steps involving mechanical agitation and/or clay floatation can be performed with the fines, if desired, before additional chemical agents are added to facilitate the purification process.

Generally, flotation methods of separating and processing copper, lead, zinc, phosphate and sylvinite ores, as well as other ores are known. For potash ores containing sufficient amounts of clay minerals, the ore is processed to remove a significant portion of the clay prior to floatation, also known as desliming. Typically, clays are removed by mechanical means or by floatation of the clay minerals. Generally, the clays that are separated from the ore are transported to settling tanks to settle the clay and allow recycling of clarified brines. The settled clay slurry can be discarded or can be further processed to recover some of the associated brine. Improved brine clarification and brine recovery can increase the overall recovery of potassium minerals from the ore.

A floatation process generally uses several chemicals and several processing steps to obtain the desired end-product. Floatation is a process wherein a depressant or “blinder” chemical is introduced to a slurry of the crushed and prepared ore particles. The crushed ore particles commonly contain the desired end-product, but also contain various unwanted or interfering mineral compositions such as pyrites, pyrrhotite, and clay. The depressant is designed to bind with the unwanted portion of the slurry such that only the desired material is floated in the floatation process. A collector chemical is added to the slurry to coat the desired material and facilitate floatation of the desired material, which can be separated from the processed slurry.

Generally, in the potash ore refining process, potassium chloride (KCl) is the desired end-product of the refining/flotation process, although other minerals can be present in the ore that have market value. The processes herein will address KCl as the common desired mineral, but those knowledgeable in potash ore processing will understand the benefits of the invention would apply to other potash ore mineral processing that utilize desliming of the clay in the ore or floatation of minerals other than KCl. The KCl is often referred to as muriate of potash in the agricultural industry, where muriate of potash is commonly used as a fertilizer or as an animal feed ingredient. Potassium is an important element for plant growth, and muriate of potash added to the soil provides the needed potassium.

Once initial purification or desliming is completed to a desired degree, the ore can be further processed in a first conditioning step, where depressant or blinder is added. Also, collector and frother chemicals can be added, which addition can be performed in a second conditioning step, or other addition locations in the circuit, if desired. Alternatively, collector and extender chemicals or collector, extender and frother chemicals can be added separately or in an emulsified form. Then, the conditioned mixture can be transported to the flotation cells, although the process can be performed in the same vessel if desired. In the flotation cells, air can be introduced and contacted with the solids in the slurry. Frother can be added to improve bubble sizing and strength of the froth, to facilitate flotation of the salts and dispersion of the collector. Air bubbles attached to the potassium chloride salts lift them to the top of the flotation cells and form a froth mat. The floated minerals are removed by cell overflow velocity, by paddles into another tank, or are removed from the top of the tank in some similar fashion. From the initial purification steps the undesired clay material can be transported to thickeners or settling tanks, where the clay settles, thereby clarifying the brine. The clay and other undesired insolubles are disposed as waste or further processed to recover the associated brine, and the clarified brine is recycled, to be available for use in the process again.

The minerals skimmed from the flotation cells may require leaching or other means to improve purity. Subsequently, the brine is removed from the desired minerals and these moist solids can then be dried. The product can be sized to produce final products, can be further refined, or can be agglomerated to increase its size.

A floatation process for potassium chloride purification generally involves the use of several chemicals and several processing steps in order to obtain the desired end-product. In the case of producing muriate of potash (potassium chloride) from potash ore, generally the following chemicals are used in the process; a carrier, a depressant or blinder, a collector, an extender, a frother, and a flocculant. The carrier is generally a liquid vehicle for the ore particles, and can form a slurry with the ore particles, including the salts and clay. The depressant or blinder chemical can interact with at least some of the material that is not desired, so that the desired material may more readily be floated and collected. A collector chemical can interact with a substantial amount of the desired material and assist in effecting floatation of the desired material. An extender chemical can assist the collector chemical in floating the desired material. A frother chemical can assist in generating a froth of air bubbles and/or can aid dispersion of the collector, to help effect floatation of the desired material. A flocculent chemical can effect the agglomeration of the separated undesired material, such that the carrier can be clarified and used in the floatation circuit again.

However, it has been discovered that the introduction of urea-formaldehyde based polymers into the processing of potash ore can result in significant improvements, such as the reduction or elimination of certain conventional processing compositions and yet maintaining or improving the percent recovery of the muriate of potash (KCl) from the potash ore. These improvements can result in significant cost reductions and/or other efficiencies.

A carrier solution can be introduced to form a slurry with the crushed potash ore, thereby providing a medium within which the various reagents may operate and within which the ore can be processed and transported, without solubilizing the potassium chloride to an inappropriate degree. The carrier solution can be a brine saturated in potassium chloride and sodium chloride or other potassium chloride saturated brine produced by contact with the ore, as described further below.

A depressant or “blinder” chemical is introduced to interact with at least some of the material that is not desired, so that the desired material can be floated in the floatation process. There are a number of methods by which the depressant may facilitate the removal of unwanted material from the floatation process. For example, while not wanting to be limited by theory, the depressant may absorb onto the surface of the unwanted material, thus making it unavailable for floatation, or the depressant may cause the unwanted material to no longer adhere to the desired material, or the depressant may prevent the “collector” chemical from adhering to the unwanted material. Another possible method of removing the unwanted material from the floatation process is by the depressant making the unwanted material less hydrophobic and therefore more apt to interact with water and less apt to interact with the air bubbles used for floatation.

Generally, clay is an undesired material in the potash refining process. The depressant can be selected to bind or otherwise interact with the clay portion of the potash/brine slurry such that a higher portion of the desired salt particles are floated in the flotation process. In the potash ore flotation process, in particular, water soluble, high molecular weight diallyl dialkyl quaternary ammonium polymers, polyglycols, water soluble acrylaminde-beta methacrylyloxy-ethyltrimethylammonium methyl sulfate copolymer, polygalactomannans and other carbohydrates such as carboxymethylcellulose (CMC) and starch and intermediate condensation products of a carbamide compound and a lower molecular weight aldehyde, such as urea-formaldehyde, melamine-formaldehyde and the like, have been used as depressants.

In the present improved floatation process, urea-formaldehyde resin is added to the brine slurry containing crushed potash ore. The term, urea-formaldehyde resin, is understood to mean urea-formaldehyde resins and derivatives of urea-formaldehyde resins. The urea-formaldehyde resin acts as a depressant and is thought to bind with the clay particles, thus making the salt particles available for floatation. The urea-formaldehyde resin can be used alone or in combination with other traditional blinders/depressants as stated above. The combination of urea-formaldehyde resin and other blinders/depressants such as guar gum, or urea-formaldehyde resin alone, holding other floatation reagents constant, results in improved float percent recovery of the KCl, over using CMC, starch or guar gum alone. Surprisingly, the continued addition of blinder/depressant such as CMC, starch, or guar gum (e.g. doubling the amount of guar gum), beyond a conventional amount, can actually decrease KCl recovery and/or lower concentrate purity. The urea-formaldehyde resin can be used as a blinder/depressant alone, with improved float percent recovery of KCl, similar to results wherein a combination of guar gum and a reduced amount of urea-formaldehyde resin are used.

Urea-formaldehyde resins, generally, are usually thermosetting-type polymers made from urea and formaldehyde monomers, such as from the heating of the monomers in the presence of a mild base such as ammonia or pyridine. The ratio of urea to formaldehyde generally ranges from about 0.8:1.0 to about 1.0:3.0, dependent upon the ultimate application of the product. The condensation reaction at completion results in a highly insoluble thermosetting resin with good hardness and abrasion resistance. These types of urea-formaldehyde resins are not effective in the floatation process since they cannot be dispersed in an aqueous pulp. However, if the condensation reaction is carried to a point where the solution of ingredients becomes viscous but retains significant water solubility, the urea-formaldehyde resin thus formed can be effective in floatation. The intermediate can be a blend of methylolurea and dimethylolurea, (H₂NCONHCH₂OH; HOCH₂NHCONHCH₂OH) as well as methylene urea and dimethylol urone. A person of ordinary skill in the art can select appropriate molecular weight ranges for the urea-formaldehyde resin to obtain a highly viscous composition that is dispersible in the brine. Generally the molecular weight is greater than 1,000 and can be greater than 100,000. In further embodiments, the molecular weight can be 100,000 to 200,00, and further embodiments from 120,000 to 325,000. Further details of formation of urea-formaldehyde resins and other carbamide and aldehyde condensation products can be found in U.S. Pat. No. 3,017,028 to Schoeld et al., which patent in incorporated by reference.

However, reduction in the amount of urea-formaldehyde resin below a predetermined range, holding other flotation reagents constant, results in decreased float percent recovery of KCl. Further, increasing the amount of urea-formaldehyde resin used beyond a predetermined beneficial range does not significantly further improve the float percent recovery of KCl.

Russian patent RU 2165798 suggests use of a urea-formaldehyde resin or a modified carbamide-formaldehyde resin with a weight ratio urea-formaldehyde-to-polyethylenepolyamine of 1:1.12:0.05-1:2.70:0.30 as a blinder/depressant. Increased amounts of the urea-formaldehyde resin or the modified carbamide-formaldehyde resin resulted in improved percent KCl recovery. Russian patent RU 2165798 is herein incorporated by reference.

Although Russian patent RU 2165798 disclosed the use of urea-formaldehyde as a depressant and the attendant improvement in percent recovery of KCl, it has been discovered that additional process improvements can result from the use of the urea-formaldehyde polymer, such as the reduction in amount of collector used as a percent of ore, reduction of the conventional frothing agent, ability to float coarser ore and reduction in amount of flocculant used as a percent of “tails” or slime waste product. The percent recovery of KCl can be maintained or increased, concurrently with the above-noted process improvements.

With much of the unwanted material unavailable due to the presence of the depressant, a collector chemical can be added to the process and is thought to modify the surface of potassium chloride particles to better adhere to air bubbles generated in the process tank. The collector associated with the desired salt material promotes association with the air bubbles. Suitable collectors may include, for example, cationic surfactants, such as amines with 10-24 carbons; fatty amines, especially amine salts such as octylamine hydrochloride and octadecylamine acetate. Generally, saturated and unsaturated straight chain aliphatic amines and their water soluble salts are known in the art to be collector reagents.

A surprising result when using the urea-formaldehyde resin as a blinder/depressant, alone or in combination with other depressants, is that the amount of collector reagent can be reduced, as compared to a process where urea-formaldehyde resin in not present, to achieve similar or improved float percent recovery of KCl. That is to say, similar or improved yields of KCl can be achieved using less collector reagent when urea-formaldehyde resin is present as compared to using the same collector and no urea-formaldehyde resin is present

A frother chemical can be introduced to the slurry to aid in creation of a froth of air bubbles or to aid in the dispersion of the collector. Air can be introduced to the frother-containing slurry, causing the formation of many small bubbles. The bubbles adhere to the desired salt material and float to the top of the floatation tank, leaving the unwanted clay material behind. The process continues as the salts are transported to another tank in the froth, leaving the undesirable material behind. Frothing agents that may be used include the C-8 to C-12 aliphatic alcohols, propylene glycols and ethers or esters of glycols, or mixtures of any of these agents.

A surprising result of using the urea-formaldehyde resin is that less frother or frothing agent is needed to obtain similar percent KCl recovery levels. The frother levels can be reduced as compared to equivalent processes that do not contain urea-formaldehyde resin and still maintain or increase the percent KCl recovery. The reduction of the amount of frother can range from 1% to effectively no frother usage. The urea-formaldehyde resin may perform the function of the frothing agent and assists in the generation of air bubbles, which then adhere to the salts and float the salts to the top of the tank. When a traditional frothing agent, such as a “water soluble” alcohol-based frothing agent, is added to the flotation mixture, with the presence of urea-formaldehyde resin, poorer flotation of the salt and lower percent KCl recovery result as compared to using the urea-formaldehyde resin alone with no alcohol-based frothing agent. These ‘water soluble’ frothers have a relatively high solubility in water or brine.

Further, it was discovered that with the presence of the urea-formaldehyde resin coarser sized ore can be effectively processed to purify KCl, thereby allowing for more flexibility in grinding of the potash ore. The ability to float coarser sized ore can result in reduced grinding requirements and can also eliminate the need for regrinding and resizing the ore and reduce losses of fine KCl to the clay settling tanks. However, coarser sized ore, i.e., ore with larger sized ore particles, can result in non-liberated minerals, which is undesirable since it reduces the ability to float the KCl. Generally, free clay in the purification composition hinders coarse KCl floatation. But, better depressing of the clay by the urea-formaldehyde resin results in the percent recovery of KCl from coarse ore particles to increase. Hence, a higher percentage of KCl is floated instead of going to tails due to better blinding of the clay. If the refining process has limitations based on grinding equipment then additional ore sizes, and hence more ore, can be processed due to the reduction of grinding requirements. For example, more plus 10 and 14 mesh ore can be floated and fewer stages of clay desliming are possible.

Use of urea-formaldehyde resin in the potash ore floatation process results in the increased percent recovery of KCl (muriate of potash). Further, the muriate of potash recovered from the floatation process wherein urea-formaldehyde resin is used, is generally of a higher quality than the muriate of potash produced in a froth floatation process not utilizing urea-formaldehyde resin. Hence, the muriate of potash that has been thusly recovered contains less undesirable material. The reduction of undesirable fine clay material in the recovered potash and/or the ability to recover coarser potash results in increased porosity in the potash in the centrifuge, which allows for improved dewatering.

Further, it was discovered that the urea-formaldehyde resin is better able to process higher levels of clay and spikes of high clay in the ore, as compared to use of a traditional blinder/depressant such as guar gum. The urea-formaldehyde resin appears to be more efficient at blinding higher levels of clay than traditional blinders. Hence, ore that was previously thought to be too difficult to refine, due to the levels of clay, may now be able to be cost-effectively refined in the flotation process. Further, fewer desliming stages may also be possible due to the use of urea-formaldehyde resin despressant.

A flocculant such as a polyacrylamide may be added to the brine and brine/clay mixture that has been transported to a thickening tank. In the tank, the clay settles and the brine is clarified. The flocculant assists in settling the separated, undesired clay material, such that the brine is clarified and recycled to be used again in the flotation process. The undesired clay material is settled and the concentrated slurry is disposed as a waste or tailing of the potash ore refining process, or alternatively, can be processed to recover more of the brine.

A further surprising result of using the urea-formaldehyde resin is the clay flocs that are formed with the use of a flocculent, in the presence of residual urea-formaldehyde resin, do not breakdown as easily as when just a flocculant is used. The clay-to-clay bonds are stronger, which results in less required flocculant to form the clay flocs, and increased clarity of the brine slurry since the clay flocs are less inclined to break-up. Flocculant usage can be decreased about 1 wt %-50 wt % based upon weight of “mud” or waste slime as compared to an equivalent process where a urea-formaldehyde resin is not present. However, some flocculent generally is still used.

If the concentrated clay slurry is processed to further recover brine then, with the urea-formaldehyde resin present, the liquid removal rates of the slurry are significantly increased. The filtration of the brine from the clay can be accomplished using various systems. Since it is not desirable to have fine salts or individual clays in the settling tanks, a flocculent is used to agglomerate these materials, as noted above. Fine salts can pack together and result in limited porosity that is needed to remove the brine from the solids. As a result of the added flocculent, the floc'ed clay is unable to pack tightly, thus leaving a pathway through which the brine can pass. Centrifuges, drum and horizontal vacuum filtration, pressure filtration or combinations can be used to clarify the brine.

Hence, the capacity of the vacuum filter or similar equipment that removes the brine from the settled clays can be increased by at least 1% on a volume/hour basis. In some instances the filtering capacity of the used equipment can increase 30% on a volume/hour basis on up to over 100% increase on a volume/hour basis, as compared to a similar process without the presence of a urea-formaldehyde resin. Efficiency of the gravity thickeners and clay filtration is improved. A person of ordinary skill in the art will recognize that subranges within these explicit ranges are contemplated and are within the present disclosure.

While the percent recovery of potassium minerals is generally dependent upon the composition of the input ore, the use of urea-formaldehyde resin generally facilitates the maintenance or improvement of the percent recovery of potassium minerals, while improving process parameters. In some embodiments, the percent recovery of KCl is about 85% relative to input to the floatation step. In other embodiments, the percent recovery of KCl is 90%, and in other embodiments, 95% recovery or better. A person of ordinary skill in the art will recognize that subranges within these explicit ranges are contemplated and are within the present disclosure.

### Potash Ore

Potash ore reserves exist only in certain areas of the world. The economic sources of muriate of potash generally occur in sedimentary salt beds, the evaporative deposits of ancient inland seas. Large potash ore reserves are primarily found in Russia, Canada, Germany, the United States (North Dakota, Montana, New Mexico, Colorado and Utah), and Brazil. Canada and Russia combined have approximately 75% of the world's reserves of potash ore.

There are a number of potassium-containing minerals that may be present in commercial potash deposits. The term potash generally refers to a variety of minerals containing potassium (K) such as sylvite and sylvinite. Sylvite is the most abundant potassium mineral in commercial deposits. Sylvite and halite (NaCl) form sylvinite, which is a common potash ore. Potash ores can contain other impurities such as kieserite [MgSO₄.H₂O], CaSO₄, polyhalite [K₂SO₄.2MgSO₄.2CaSO₄.H₂O] and langbeinite [K₂SO₄.2MgSO₄].

Potash resources can vary in K₂O content, particle size, mineralization and other characteristics which affect the process for processing the potash ore. The potash ore in Canada (Saskatchewan) is generally high grade ore (25-30% K₂O) of uniform mineralization containing sylvinite, some carnallite and clay (42% KCl, 53% NaCl and 5% clay). Potash ores mined in the United States, Carlsbad, New Mexico, for example, generally contains sylvite and langbeinite and has 12% K₂O and 5-10% clay content. Potash deposits in Russia known as the Verkhnekamsk deposit in the Ural area contain about 15% K₂O and 3-5% insolubles, and deposits in Germany generally contain about 10-15% K₂O and can have few insolubles or 5-10% MgSO₄, dependent upon location.

The potash processing method described herein is particularly effective when using ore from Carlsbad, New Mexico or similar content ore. The method is particularly effective in removing clay and concurrently providing good yields of muriate of potash (KCl). However, the method has application for other sized and mineralized potash ore.

### Potash Flotation Process

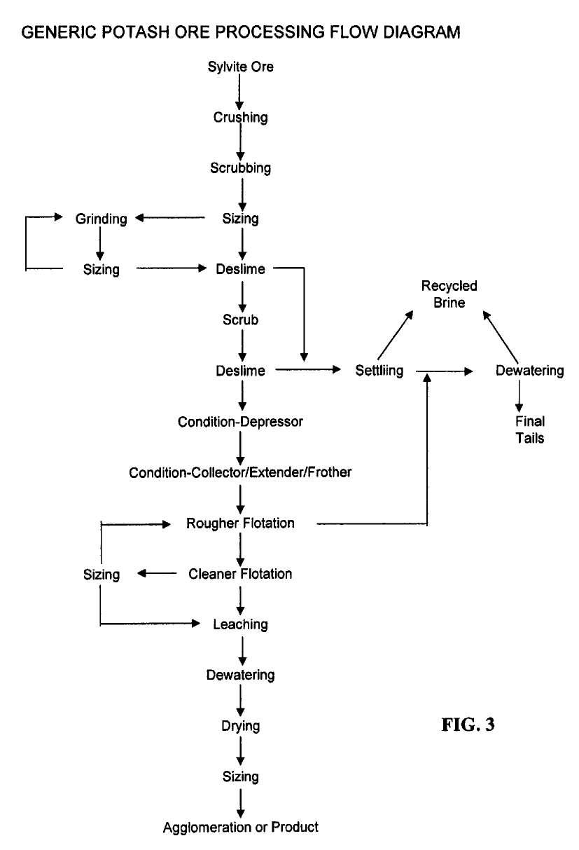

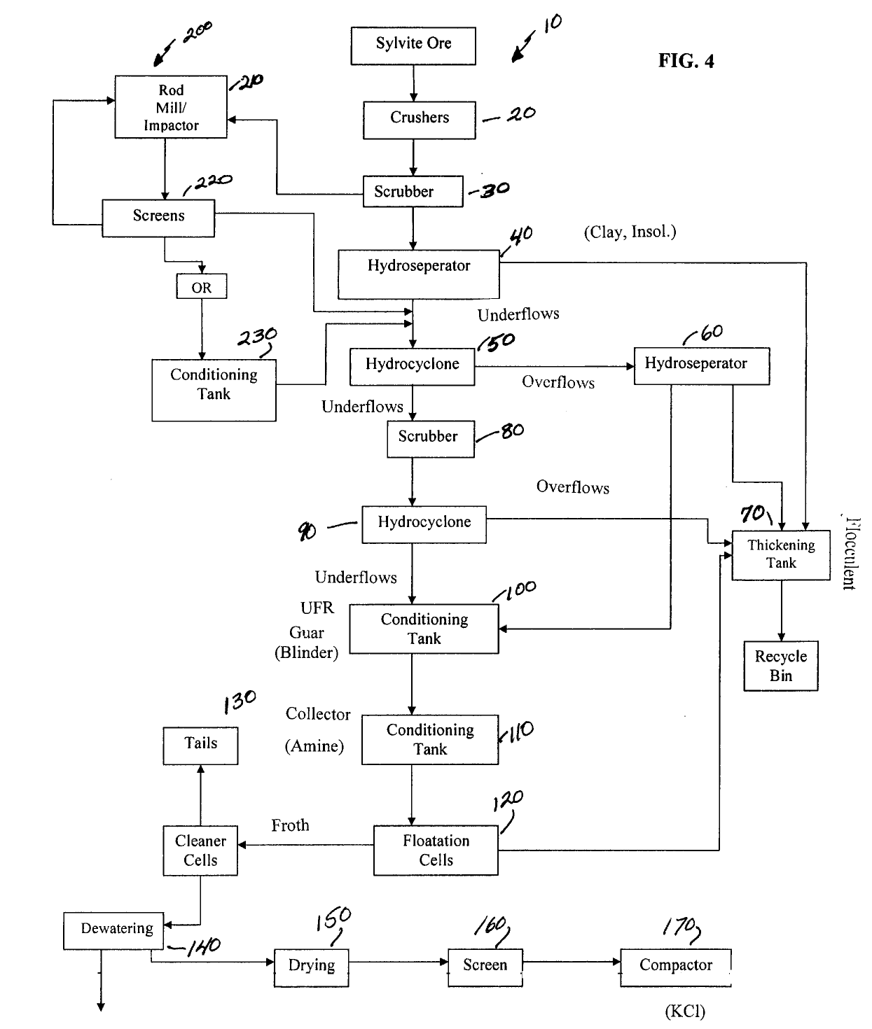

A schematic diagram of a generic potassium chloride flotation refining process is shown in FIG. 3 and an embodiment of a potassium chloride flotation refining process 10 providing more detail is shown in FIG. 4. The embodiments of potassium chloride floatation refining processes provided herein are given as examples of several alternatives known to those knowledgeable in potash ore processing.

In the refining of potash ore, the potash ore can be crushed 20 such that the particle size of the ore is reduced to make flotation of the ore more easily accomplished. The potash ore may contain a variety of materials such as clay that are contaminants relative to the desired KCl. After the potash ore is crushed, the ore generally is mixed with a saturated brine solution.

The crushed potash ore and brine mixture can be transported to scrub tanks 30 or the like, where the potash ore is scrubbed 30 such that any clay that is adhered to the potash ore is broken up, loosened and dispersed into the brine slurry. The scrub tanks are tanks with agitators, and the agitation of the potash ore and brine in the tank causes some of the undesirable material (e.g. clay) to be mechanically separated from the potash ore. The clay material is broken-up into finer particulate matter. The function of both the scrub tanks 30 and/or attrition scrubbers is to mechanically remove clay from the potash ore and to breakdown the clay into fine particulate matter. Manufacturers of attrition scrubbers include, for example, Westpro, Outokumpu, Metso, Minpro, Titan Processing Equipment, Ltd., and QPEC.

After the potash ore has been scrubbed 30, in some embodiments the ore/brine mixture can then be pumped to different processing circuits based upon the size of the particulate matter. For example, the crushed and scrubbed ore can be passed through classifiers/hydroseparators that separate the fine ore from the coarse ore. The fine ore or “fines” pass through a size classifier to be sized and then proceed to desliming operations. Dependent upon the ore, floatation of coarser particles may be possible. The coarse ore proceeds to fine milling operations designed to further crush the larger pieces of potash ore. Further in the floatation process, the fine ore and the coarser ore are conditioned separately. After conditioning, the coarser ore may join the fine ore floatation circuit. Material classifiers are available from suppliers such as Alston, Krebs, Derrik Manufacturing and RSG Inc.

The use of urea-formaldehyde resin allows for conditioning the ore in one conditioning step, for all the ore, instead of conditioning the coarser ore in a separate conditioning step. See FIG. 4. The coarse ore is subject to further crushing, such as with rod mills, if the ore is not of the desired size, although the size range may now be broadened. Once the desired size is achieved, the ore joins the fine ore at a hydrocyclone for separation of the undesired material (e.g. slime) from the ore. The use of a hydroseparator step in the floatation process utilizing urea-formaldehyde resin is not required, but is optional.

Fine Ore Processing Circuit

The fine ore (fines) collected from minus 28-mesh classification is transported to a hydroseparator 40 or other material separating vessel such as a hydrocyclone or the like. The hydroseparator 40 is basically a settling device wherein the desired salt matter can settle to the bottom of the hydroseparator vessel 40. The hydroseparators 40 have a rake and a center-point discharge at the bottom of the vessel, so the settled material (e.g. salts) can be discharged. The rake assists in discharging the solids from the bottom of the hydroseparator vessel 40 by scraping the material on the bottom of the vessel and moving the material towards the discharge point. The rise rate in the hydroseparator 40 can be controlled so that the particulate matter that is desired to be overflowed can be overflowed into the next step and the particulate matter that is desired to be settled, settles at the bottom of the tank. The rise rate is the rate at which particulate matter rises to the top of the vessel. A faster rise rate corresponds with the floation of more and heavier material to the top of the vessel. A slower rise rate corresponds with the floatation of lighter material to the top of the vessel.

The objective of the hydroseparators 40 is to overflow dispersed clay while leaving potassium chloride salts in the bottom of the hydroseparator 40. However, some fine salts will be overflowed with the clay matter and some dispersed clay matter will be pumped along with the settled salts from the bottom of the hydroseparator 40. Therefore, the settled salts generally need further processing to eliminate more of the clay material. Suppliers of hydroseparators include, for example, Titan Process Equipment, Ltd., Sterns Rogers, WesTech, Inc., Cattani, SpA., and Mario di Maio SpA.

The settled material from the underflow from the hydroseparator 40 comprises primarily salts and some dispersed clay in brine. To simplify the discussion, terminology is adopted in which the underflow is the settled material that is discharged from the bottom of a vessel and the overflow is the material that is discharged from the top of the vessel. In the described process, the salt material is generally primarily in the underflows and the clay material is generally primarily in the overflows. The clay has been dispersed in the brine and further brine is added as needed to dilute the clay. Next, the underflow is transported to a hydrocyclone 50. The hydrocyclone 50 is a centrifugal force separating device that aids separation of the salt material from the clay material. In the hydrocyclones 50, most of the salts report to the underflow and most of the brine and clays report to the overflow. Hydrocyclones 50 are available from suppliers such as Titan Processing Equipment, Ltd., Krebs Engineers, and Weir Minerals.

The hydrocyclone 50 overflow, which mainly contains the clay material, is transported to a second series of hydroseparators 60. The second hydroseparator 60 feed material, which is the clay-containing overflow from the first hydrocyclone 50, is sized near 150 mesh with plus 150 mesh settling and minus 150 mesh particles reporting to the overflow. The overflow of the second series of hydroseparators 60 mainly contains the clay material, and the fine salts settle on the bottom of the hydroseparator 60. The second series of hydroseparator 60 overflow (containing the clay material) is transported to a thickening tank 70 where the clay is settled and the brine is clarified. The clarified brine can be recycled for use again in the floatation process. A flocculent can be added to the thickening tank 70 mixture to assist in settling and concentrating the clay into a type of “mud” or slime, often referred to as “tails”.

The settled solids from the first stage hydrocyclone 50 underflow are transported to a scrubber 80, and the particles can be further diluted with saturated brine. The agitators in the scrubber use mechanical energy to breakdown the clay material or scrub the clay material off the surface of the salt material. The material from the scrubbers 80 is transported to another set of hydrocyclones 90. The hydrocyclones 90 further separate the salt material from the clay material.

The second hydrocyclone 90 overflow primarily contains the clay material. This clay and brine mixture is transported to the thickening tank 70, e.g. a gravity-settling tank. Although the overflow has been through a number of processing steps, there are still some salts in the hydrocyclone 90 overflow, albeit less than in previous steps. Salts remaining in the clay-containing hydrocyclone 90 overflow may represent some unrecovered end-product. A flocculent can be added to this largely clay/brine mixture to settle the clay and clarify the brine so that the brine may be reused.

The underflows from the second series of hydrocyclones 90 mainly comprise fine salt solids, which are ready to be conditioned for flotation. In one embodiment, the underflows from the second series of hydrocyclones 90 are joined with the second series of hydroseparator 60 underflows. In each case, the underflow material mainly comprises fine solids or cleaned-up ore, with significant amounts of the clay material removed. However, there generally is some residual clay remaining in the fine ore. Both of these underflows are transported into a conditioning tank 100.

The conditioning tanks 100 contain mixing blades to blend processing reagents added to the tank with the cleaned-up ore. In the conditioning tanks 100 the salt mixture is “conditioned” with various reagents to promote flotation of the desired salt material. While the above description describes a commercially viable approach for preparing the ores for floatation that results in significant improvement in purification, other approaches can be used to perform initial purification, or no initial purification can be used if the ore is appropriate or if sufficient purification can be obtained solely from the flotation step. The improved features of the flotation process result in improvements regardless of the initial preparation of the materials. Conditioning tanks are available from any major supplier of agitators such as Lightning.

In the first conditioning tank 100, drum, baffled launder or the like, “blinders” or depressants are added to the partially purified product to adhere to the remaining clay. In this fashion, the depressants “blind” the clay or “tie-up” the clay material. The “blinded” clay material is not available to be floated by the collector chemicals or “collectors.” As previously described, blinders can include water soluble, high molecular weight diallyl dialkyl quaternary ammonium polymers, polyglycols, water soluble acrylaminde-beta methacrylyloxy-ethyltrimethylammonium methyl sulfate copolymer, polygalactomannans and other carbohydrates such as carboxymethylcellulose (CMC) and starch, and urea-formaldehyde resin.

After the clay is “blinded,” the mixture is transported to a second conditioning tank 110, drum, baffled launder or the like, where “collectors” or collecting reagents are added to make the desired mineral (the fine salts) more hydrophobic so that the material adheres to air bubbles. The collector has an affinity for the surface of the potassium chloride. At this point, the clay is associated with the depressant reagent so that it is not available to adhere to or absorb the collectors. Collector chemicals can include various aliphatic amines including acid salts of primary amines, typically primary aliphatic amines with carbon lengths of C-10 to C-24, but more typically C-14 to C-18. In some embodiments, an oil extender is added to assist in collecting the desired particles.

In some embodiments, a frother agent is now added to the mixture to promote formation of small air bubbles. However, if urea-formaldehyde resin is used as the depressant or “blinder”, the addition of a conventional frother is unnecessary. It appears that the presence of the urea-formaldehyde resin assists in promoting air bubble formation, which is needed to float the salt.

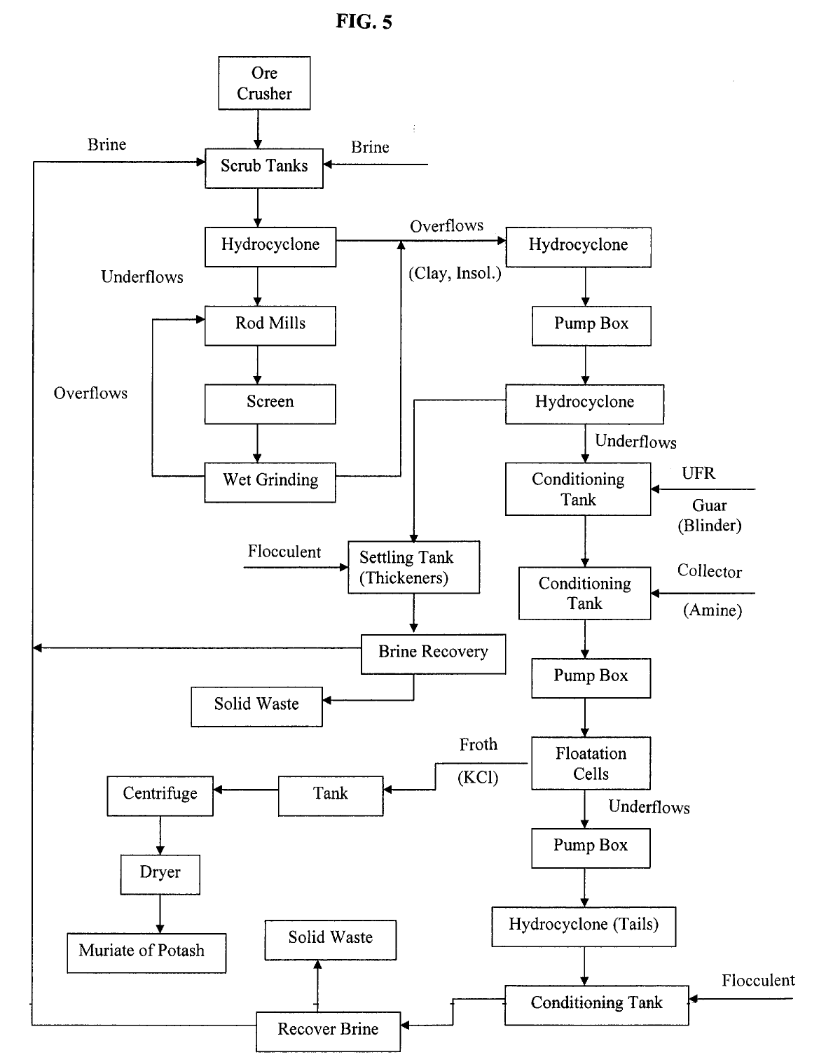

The mixture containing the depressants and collectors is pumped into floatation cells 120. Material from the coarse ore circuit 200, described below, can be joined with the mixture in the flotation cells 120. However, use of urea-formaldehyde resin in the floatation process facilitates the coarse ore joining the floatation circuit much earlier, at the hydrocyclone, as shown in FIG. 5. FIG. 5 is another embodiment of the potash ore floatation process, showing some of the process benefits of using urea-formaldehyde resin as the blinder chemical. The floatation cells 120 are tanks with or without agitators that have means to induce air into the slurry in the tank, to promote the generation of small air bubbles and flotation of the desired material. Initial floatation cells are commonly referred to as “rougher” floatation cells. Once the air enters the bottom of the tank, it bubbles up to the top of the tank, producing the bubbles needed for floatation of the ore. The salts/collectors are attracted to air bubbles and are “collected” by floating to the top of the vessel. Floatation cells are available from suppliers such as QPEC, Metso, and Titan Process Equipment, Ltd.

The floated salt can be removed by paddles, used to skim off the froth containing the salts or the floated salts can be overflowed into another vessel or a second cleaner floatation circuit by controlling the liquid level. The rougher floatation concentrate containing the refined potash can be maintained in this vessel, or retention tank, or further purified in the cleaner floatation circuit prior to being transported to the centrifuge Or brine removal device. If the rougher floatation cells underflows contain a sufficient concentration of potash, then the underflows can be transported to a scavenger 130 flotation circuit where the underflows can be processed further. The floatation concentrate containing the refined potash is transported from the flotation cell to the concentrate retention tank. The cleaner floatation tails can be screened to remove fine salts, with the fine salts being routed back to be floated again, or proceed to dewatering and brine reclamation steps.

The froth concentrate is typically leached with minor amounts of water or KCl brine and dewatered 140 prior to drying 150. The dewatering process may include filtering and centrifuging the potassium chloride. Residual sodium chloride (NaCl) is leached out with water or brine not saturated in sodium chloride. Dewatering filters and centrifuges and similar systems are available from suppliers such as Lemtech, Bird Manufacturing, GE, and others. However, other types of similar dewatering equipment work adequately. The dewatered potassium chloride then passes through a drying step 150. The dried potassium chloride is screened 160, for final product, or portions can be further refined or agglomerated to increase the particle sizing 170.

The filtration of the brine from the clay can be accomplished using various systems. It is not desirable to have fine salts or individual clays in the settling tanks, hence a flocculent is used to agglomerate these materials. Centrifuges, drum and horizontal vacuum filtration, pressure filtration or combinations can be used to clarify the brine.

Coarse Ore Processing Circuit

Generally, the potash ore that was not fine enough to pass through the classifiers and into the “fines” circuit is crushed further into smaller particulate matter. The ore in the coarse fraction may have too large a mass to float. Therefore, the ore can be passed through a rod mill circuit 200 or the like to further crush the potash ore. The crushed ore is pumped to screens or other sizing equipment and any material not passing through the screens, is crushed further, such as with an impactor 210. The new fines are sized 220 and can be joined with the first stage underflows from the hydroseparators 40 and are transported together to the first series of hydrocyclones 50. Although, the new fines could be introduced into alternative parts of the processing pathway. Suitable milling and grinding equipment are supplied by companies such as Westpro Machinery, Inc., Stedman Machine Company, Alston Power, Inc., and Titan Process Equipment, Ltd.

The plus 28 mesh ore from the grinding circuit can be mixed with reagents in a separate conditioning tank 230. In these embodiments, the blinding/depressant reagent can be added to the mixture of reground coarse ore and brine. In this case, urea-formaldehyde resin is used as the blinder alone, or it maybe used in combination with guar gum or other blinders. Generally, more amine collector is used in order to float the coarser particles of ore. This material joins the hydroseparator 40 first stage underflows and proceeds through the rest of the flotation process with that material and is floated in a common flotation cell. However, it was found that if urea-formaldehyde resin is used as the depressant/blinder, the underflows from the ore grinding circuit can be added to the underflows of the hydroseparator as shown in FIG. 4 or to the primary hydrocyclone overflows as shown in a modified floatation process of FIG. 5.

The brine is recovered from the flotation process and can be recycled, to be reused in the flotation process. The overflow material from the hydroseparators 40, 60 and hydrocyclones 50, 90 containing the clay matter can be transported to thickeners 70. Thickeners or thickening tanks 70 are available from Titan Pocessing Equipment, Ltd., QPEC, Eimco, Outokumpu, and Westpro Machinery Inc. A polyacrylamide or other types of flocculant can be added to create clay flocs or clay agglomerates. The clay settles in the tank 70 and forms a type of “mud” or slime that is removed from the system and disposed, e.g., as waste or can be further processed to recover some of the associated brine. The brine is clarified from the clay matter through use of the flocculant. Once the clay settles to the bottom of the tank 70 and the brine is clarified, the brine can be recycled to be used again in the flotation process.

The floatation process embodiment of FIG. 5 demonstrates some of the process benefits of using a urea-formaldehyde resin blinder. For example, a hydroseparator is not used, the coarser ore particles join the process at the hydrocyclone, and the potash ore (fines and coarse) is conditioned together instead of in separate tanks with varying amounts of blinder. The above potash floatation processes are two examples of such processes and other such processes and variations are contemplated.

### Potash Floatation Compositions

As described above, one of the first steps in the potash ore flotation refining process is crushing the ore and combining the ore with saturated brine to form a slurry. The brine is saturated with respect to potassium chloride (KCl) and sodium chloride (NaCl). Generally, the brine may comprise about 3 wt % to about 9 wt % potassium (K), no magnesium in some cases or up to about 4 wt % magnesium (Mg), about 4 wt % to about 10 wt % sodium (Na), about 13 wt % to about 19 wt % chlorine (Cl), about 0.1 wt % to about 7 wt % (sulfate) SO₄, and about 63 wt % to about 69 wt % water. A person of ordinary skill in the art will recognize that subranges within these explicit ranges are contemplated and are within the present disclosure.

One of the reagent compositions added to the slurry is a depressant, designed to interact with the clay material such that the clay material is not available to interfere with the collector reagent. Guar gum, carboxymethylcellulose (CMC) or starch is typically used as the depressant, however urea-formaldehyde resin alone or in combination with guar gum is disclosed in the present process. The use of urea-formaldehyde resin (including modified urea-formaldehyde resins) improves the percent recovery of KCl and, surprisingly, provides additional processing benefits.

Urea-formaldehyde resin is available from a variety of suppliers such as Georgia Pacific, Borden Chemicals, Dynea, DSM, CECA, Mitsui Chemicals and UralChemplast The urea-formaldehyde resin/polymer used to obtain the results described herein was obtained from Georgia-Pacific under the number GP374 G33.

The urea-formaldehyde resin is added to the processed ore (the “fines”) and brine in the first conditioning tank. The amount of active urea-formaldehyde resin added, relative to the amount of ore, ranges from about 0.003 wt %. In further embodiments the amount of active urea-formaldehyde resin added, relative to the amount of ore ranges from about 0.004 wt % to about 0.25 wt % and in other embodiments from about 0.01 wt % to about 0.1 wt %. Urea-formaldehyde resin is provided in aqueous solution. Aqueous solutions of urea-formaldehyde resin have a range of urea-formaldehyde concentrate from 4% to 70%, which may be referred to as 4% to 70% active. Hence, the amount of urea-formaldehyde resin solution used is dependent upon the concentration of urea-formaldehyde in the solution. A person of ordinary skill in the art will recognize that additional ranges of resin amounts within the explicit ranges are contemplated and are within the present disclosure.

Guar gum can be used in combination with the urea-formaldehyde resin, as a depressant. Guar gum is available from suppliers such as Atlas International and The Lucid Group, Rantech, Holimex, Economy Polymers, S&G Resources The combination of guar gum and urea-formaldehyde resin performing as the depressant reagent improves the percent recovery of KCl over using guar gum alone and is more cost effective than using urea-formaldehyde resin alone. The amount of guar gum, if used, ranges from about 0.0002 wt % to about 0.007 wt % based on dry potash ore, in further embodiments from about 0.0004 wt % to about 0.005 wt % based on dry potash ore, and in other embodiments from about 0.0007% to about 0.001 wt % based on dry potash ore. The amount of guar used is based upon the amount of clay in the potash ore, so amounts of guar used will vary with clay amounts in the ore. A person of ordinary skill in the art will recognize that additional ranges of guar gum amounts within the explicit ranges are contemplated and are within the present disclosure.

Carboxymethylcellulose (CMC) may be used in combination with the urea-formaldehyde resin, as a depressant. Carboxymethylcellulose (CMC) is available from suppliers such as ICC Chemical Corp., Kraemer & Martin GmbH, Kraft Chemical, and Dayang Chemicals Co. Ltd. The combination of CMC and urea-formaldehyde resin performing as the depressant reagent may improve the percent recovery of KCl over using CMC alone and may be more cost effective than using urea-formaldehyde resin alone. The amount of CMC, if used, ranges from about 0.0002 wt % to about 0.003 wt % based upon dry potash ore, in further embodiments from about 0.0004 wt % to about 0.002 wt % based on dry potash ore, and in other embodiments from about 0.0007% to about 0.001 wt % based on dry potash ore. The amounts of CMC used are dependent upon the amount of clay present in the potash ore, and amounts of CMC will vary with potash ore content. A person of ordinary skill in the art will recognize that additional ranges of CMC amounts within the explicit ranges are contemplated and are within the present disclosure.

### EXAMPLES

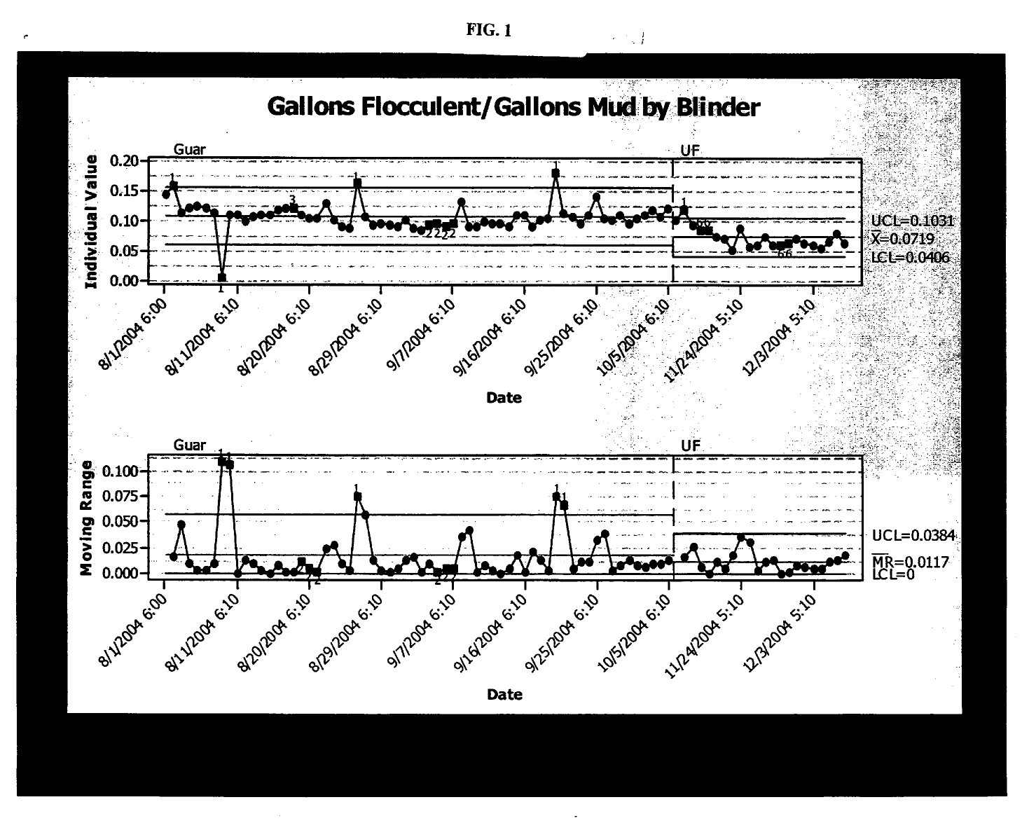

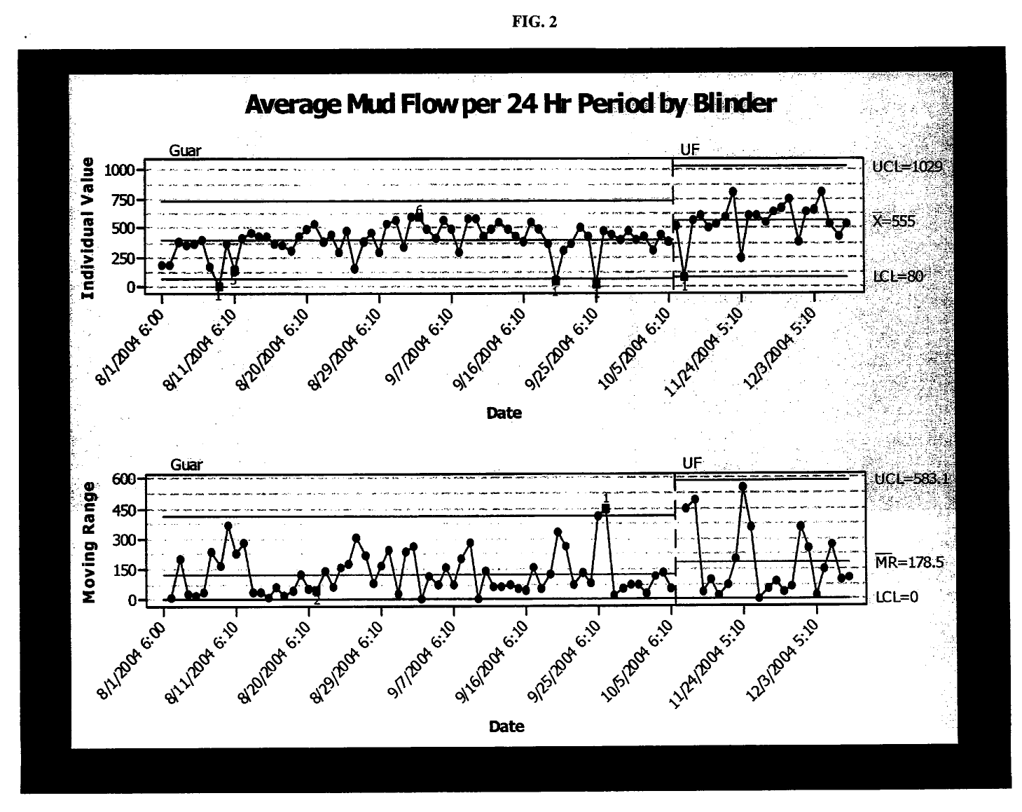

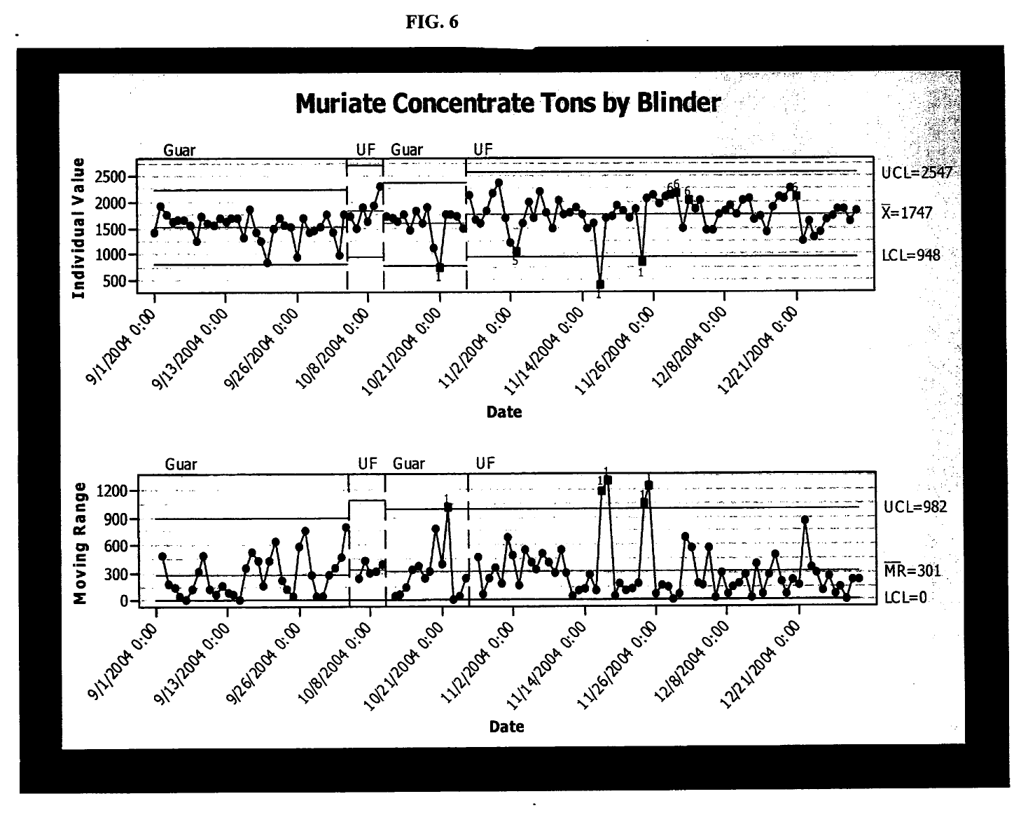

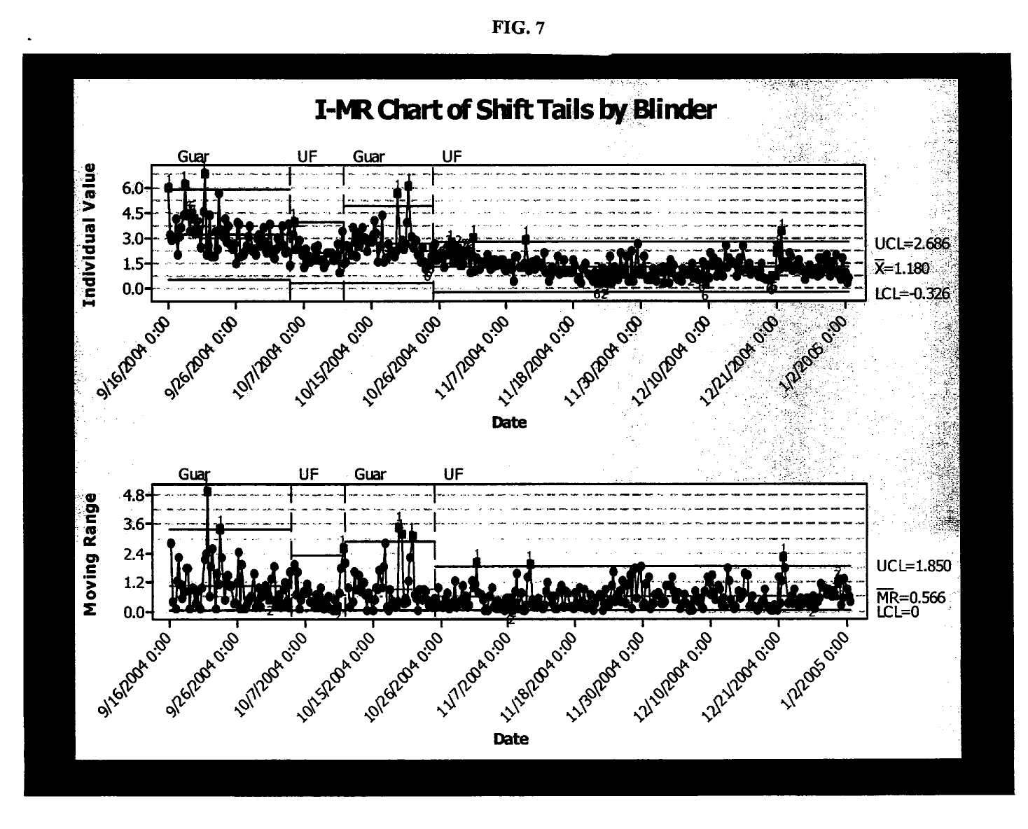

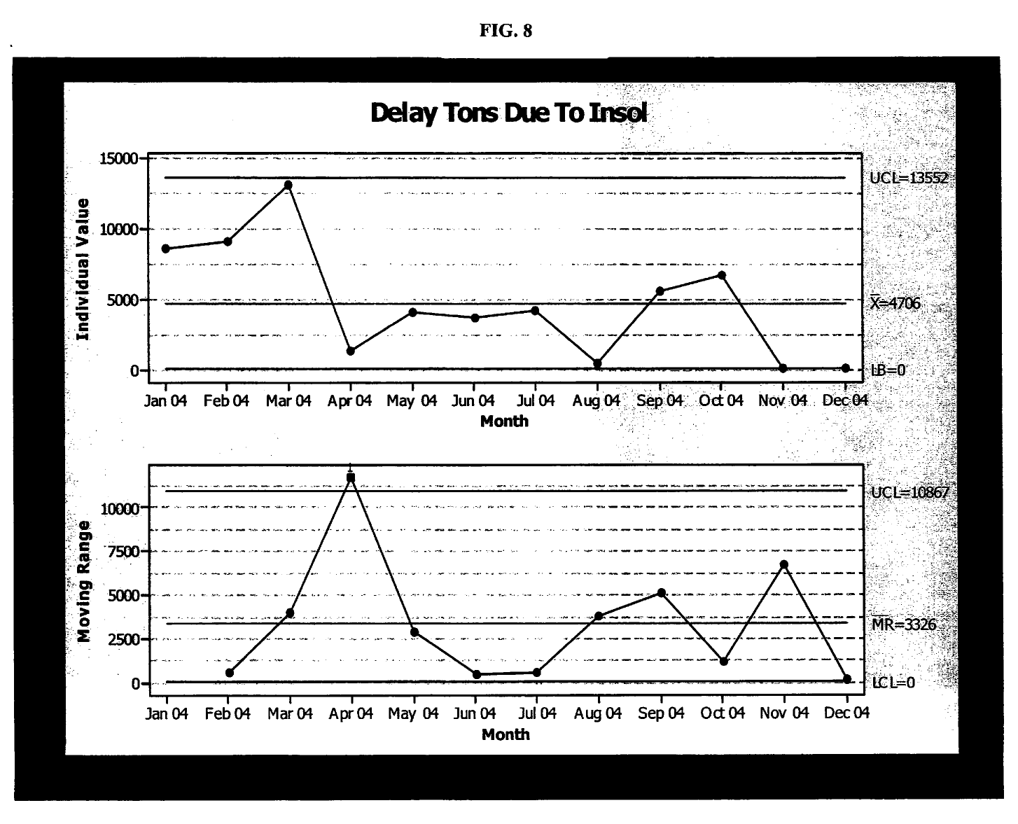

Various tests were run replacing the guar depressant with urea-formaldehyde resin as the depressant using the process and equipment essentially as described above with respect to FIG. 4. The floatation reagents that were used in the plant trials, as a wt. % of ore were about 0.003 to 0.005% dry active guar; however, when the urea-formaldehyde resin was added to the trials, the guar amounts dropped from adding no guar to 0.0007 wt. %. The plant trials were run first using guar as the depressant/blinder in the floatation process. Then the same floatation process was run using urea-formaldehyde as the depressant/blinder. In-plant trials were conducted with surprising results such as the following;
Use of urea-formaldehyde resin improved muriate of potash concentrate production by an average of about 13 wt % to about 15 wt %. FIG. 6 shows a graph demonstrating the muriate of potash concentrate production over time using the guar blinder and using the urea-formaldehyde resin as the blinder. On average, the muriate of potash concentrate produced using a urea-formaldehyde blinder increased about 15% over the amount of muriate of potash concentrate produced using the guar blinder.
Further, as shown in FIG. 7, the amount of potash remaining in the tails of the floatation process decreased when using a urea-formaldehyde blinder as compared to the guar blinder. The amount of potash residing in the tails was reduced by about 60%-65%. The reduced amount of potash in the tails represents more potash in the floatation product and a higher percent recovery of the potash from the potash ore.
Improvement in the ability to process ore with higher clay content resulted in a reduction of about 98.5% (by weight) in tons of ore lost per month and hence, increased processing capacity. See FIG. 8.
An average of about a 30% reduction (by weight) in flocculant used to settle the clay flocs and form the “mud” tailings was achieved when urea-formaldehyde resin was used as the depressant/blinder, as compared to when guar was used as the depressant/blinder. In addition, since mechanically more stable clay flocs were formed, a clearer overflow brine was maintained. The stronger formation of floc's resulted in an average increase in clay filtering capacity of about 40% (volume/hour). See FIGS. 1 and 2. FIG. 1 shows a chart demonstrating the reduction in use of gallons flocculent per gallon of “mud” or waste slime from the potash ore froth floatation process. The chart shows the amount of flocculent used when a more conventional blinder such as guar was used, as compared to the amount of flocculent used when urea-formaldehyde blinder was used. The average amount of flocculant (gallons flocculent/gallons slime) used with slime containing urea-formaldehyde resin was about 30% less, and as high as about 50% less, than the amount of flocculent used with slime containing guar and no urea formaldehyde resin, to achieve similar agglomeration of the slime particles.
FIG. 2 shows the average mud (slime) flow per 24 hour period when guar is used as the blinder and when urea-formaldehyde resin is used as the blinder. On average, the clay filtration slime flow increased at least 10%. In some instances the clay filtration slime flow increased about 30%, in others about 40% and up to about 150% relative to an equivalent process where a urea-formaldehyde resin was not present. Thus, the filtration rate of the slimes is increased, allowing equipment to more efficiently recycle the brine for reuse in the floatation process.

Without wanting to be bound by theory, the collector reagent is selected to adsorb onto the desired salt material. The collector can be an emulsion of the acid salt of an aliphatic amine (a tallow amine) and an aromatic oil or the amine collector and the extender oil can be added independently. An amine salt and aromatic oil can be used to make the potash particles more hydrophobic. An amine/aromatic oil emulsion can be used and added as a hot liquid to the brine. The emulsion adheres to the salt and are thought to make the salt more hydrophobic and more attracted to the air bubbles, such that the salt will float in the froth at the top of the flotation cell. Those skilled in the art will be aware of commonly used collector chemicals. Akzo Nobel, Degussa-Goldschmidt and Corsicana Technologies are suppliers of primary hydrogenated tallow amine. Oil for the collector emulsion is supplied by Chevron-Phillips

The grams amine added to the fines and brine mixture ranges from about 0.002 wt. % of ore to about 0.015 wt. % of ore, in further embodiments from about 0.004 wt. % of ore to about 0.01 wt. % of ore, and in other embodiments from about 0.005 wt. % of ore to about 0.009 wt. % of ore. The grams of aromatic oil range from about 0.0007 wt. % of ore to about 0.009 wt. % or ore, in further embodiments from about 0.001 wt. % of ore to about 0.007 wt. % or ore, and in other embodiments from about 0.018 wt. % of ore to about 0.005 wt. % of ore. A person of ordinary skill in the art will recognize that additional ranges of amine and oil concentrations within the explicit ranges above are contemplated and are within the present disclosure.

Generally, the amounts of reagents used in processing potash ore are dependent upon a number of variables, including for example, the mineral content of the ore, e.g. high or low clay content and type of clay, and size of the potash ore particles.

Laboratory Tests

Laboratory test were conducted regarding frother usage as well as the usage of other reagents in the froth floatation process. The laboratory procedures followed in testing the various reagents used in froth floatation and recovery of KCL are described below.

Materials

Potash ore comprising 59.50% deslimed/dewatered fine ore; 38.50% deslimed/dewatered coarse ore; 2.00% dewatered hydroseparator underflows.

0.36% wt. soln. guar gum; amine salt solution; sample of extender; sample of frother; 100 ml methanol; sample of brine thickener overflow from plant.

Feeds were caught in the plant under normal operating conditions. Samples were taken at the cyclone, quad sands and hydroseparator to obtain the potash material described above. The materials were maintained separately and were centrifuged. Prior to centrifuging the material was lightly stirred, the brine was decanted into a Buchner funnel, with the fines filtered and weighed and the centrifuged material weighed. The material was dried and ground to minus 65 mesh and the material was assayed.

Procedure

667 grams of brine and equivalent of 1000 grams of dry solids were added to a 2 liter steel beaker. The mixer (6.4 cm Lighning A-310 propeller at 696 rpm) was started. Agitation should match plant conditions. Clay blinder was added the to vortex of the slurry; generally 8 grams or less of a 0.316% guar solution and/or 0.6 grams or less of a urea-formaldehyde resin (dependent on specific test). Slurry was mixed one minute. Collector was added to the vortex of the slurry; typically 2.5 grams or less of a 3% amine with oil, frother, and acid water solution that is emulsified or not. Collector solution kept at 63C. If test requires it, drops of frother and/or warm oil added at this point. Slurry mixed one minute.

The Denver D-12 float cell was filled with about 4000 ml of process temperature brine. The agitator was turned on at 1400 rpm, with air inlet closed. The 2 L. conditioning beaker was emptied into the float cell. Brine was used to wash solids from the beaker into the cell. The material in the cell was agitated 30 seconds. The cell liquid is brought to overflow level with brine and the peristaltic pump was started for 400 ml/min brine rate. The liquid was agitated 30 seconds. The cell air valve was opened and material floated for 90 seconds for total float time of 2 minutes. Froth was skimmed into an 8″ by 14″ by 2.5″ pan. Brine was used to remove solid sticking to agitator shaft or surface level of cell wall. The peristaltic pump was turned off and the agitator was lifted out of the slurry.

Vacuum and 24 cm Buchner funnel were used with Whatman 54 filter paper to concentrate solids. Brine used as required to place solids on filter. Solids scraped off filter and weighed. A drying tray and heat lamps were used to dry the moist filtered cake. The solids were worked with a spatula and roller to minimize agglomeration if a screen assay was desired. Solids were transferred to a pan and placed in an oven to dry at least 2 hours at 300F. Weoght was recorded.

When specified solids were assayed for particle sizing solids were then ground to minus 65 mesh for K₂O assay.

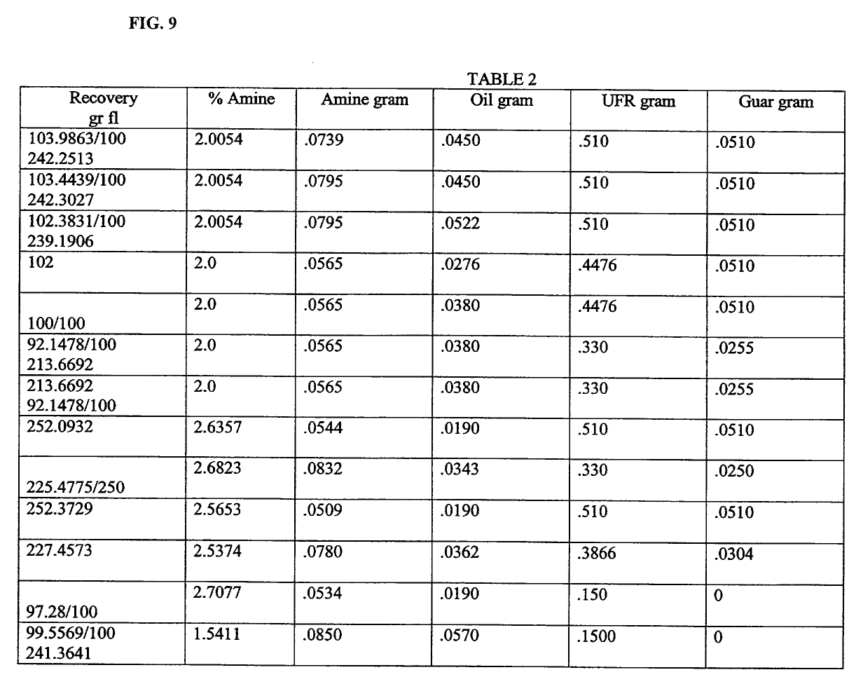

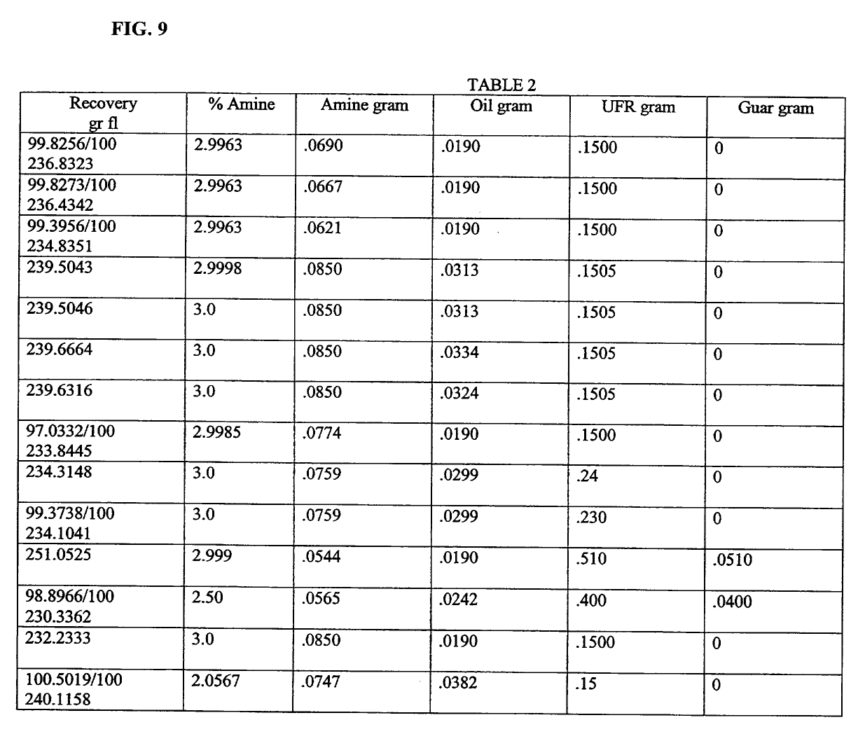

FIG. 9 shows Table 2 that demonstrates the amount of recovery of KCl (grams float) at various amounts of reagent usage. Note that when comparing the results of tests 1-3 and 4-7; there was a decrease in grams of amine used of about 19% (by weight) and about a 40% (by weight) decrease in aromatic oil used. However, these decreases resulted in less than a 2% decrease in KCl recovery. The levels of urea-formaldehyde resin were kept essentially unchanged and no guar gum was used in any of the above-noted tests.

Once the blinder and collector are added, generally a frother is added to assist in the production of air bubbles needed to float the salt material. However, with the use of urea-formaldehyde resin as a blinder, it was discovered that no frother was needed to maintain and improve percent recovery of KCl relative to approaches based on conventional blinders. Table 1 below demonstrates that use of the alcohol-based frother, OreFom F2 from Conoco Phillips, used prior to incorporating the urea-formaldehyde resin in the flotation process, reduced the calculated percent recovery of KCl. The laboratory procedures described above were followed in conducting the frother tests, which results are shown in Table 1.

TABLE 1
Frother Tests

| | UFR gr | Amine | Oil | | Float Only |
|---|---|---|---|---|---|
| Guar(dry) gr | (Active) | gr | Gr | Frother | % KCl Recovery |
| 0.0 | 0.24520 | 0.04650 | 0.03092 | 0.02213 | 93.48 |
| 0.0 | 0.24520 | 0.04650 | 0.03092 | 0.0 | 94.96 |
| 0.0385 | 0.24520 | 0.04650 | 0.03092 | 0.02213 | 90.13 |
| 0.0385 | 0.24520 | 0.04650 | 0.03092 | 0.0 | 92.68 |
| 0.0385 | 0.24520 | 0.04650 | 0.03092 | 0.02213 | 89.96 |
| 0.0385 | 0.24520 | 0.04650 | 0.03092 | 0.0 | 95.98 |
| 0.0385 | 0.24520 | 0.04650 | 0.03092 | 0.0 | 95.62 |

The amount of amine, oil and urea-formaldehyde resin were kept constant. The frother tested with the urea-formaldehyde resin is an alcohol-based frother with relatively high water solubility that was previously used in plant operations.

As noted in Table 1, referring to the first two tests, when no guar was added to the process and frother was added, the resultant percent recovery of KCl was lower than if no frother and no guar was used. In tests 3-7 above, when the amount of guar, urea-formaldehyde resin, amine and oil were held constant and the amount of frother was varied, the percent recovery of KCl was higher when no frother was used, as compared to when frother was used. The lack of frother did not result in a decrease in the percent KCl recovery as might have been expected.

Hence, no frother is used and yet percent recovery of KCl is improved and addition of alcohol-based frother worsens percent KCl recovery. The use of urea-formaldehyde resin appears to assist in the flotation process.

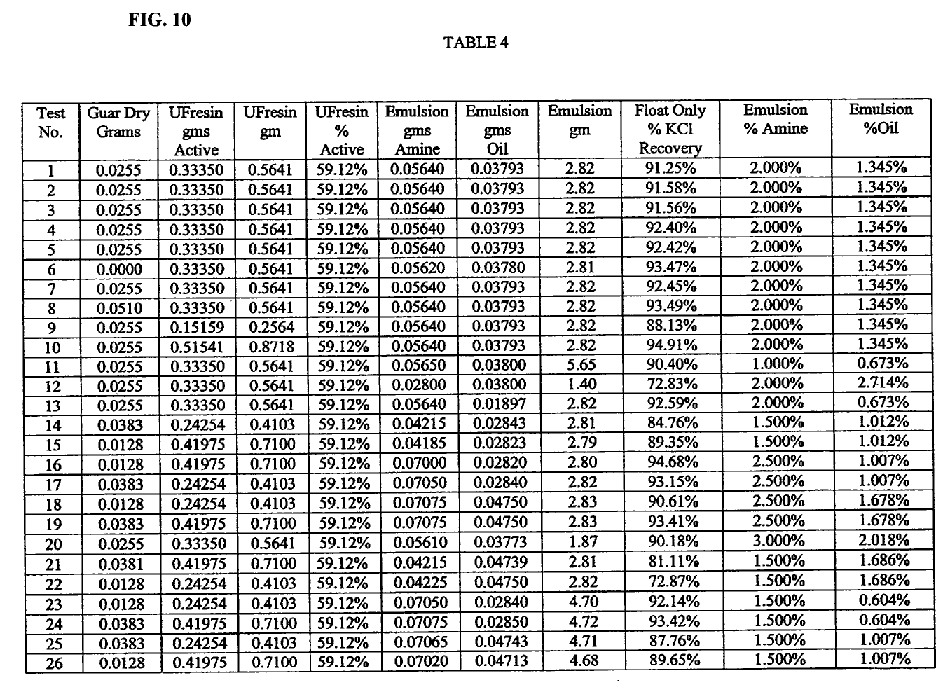

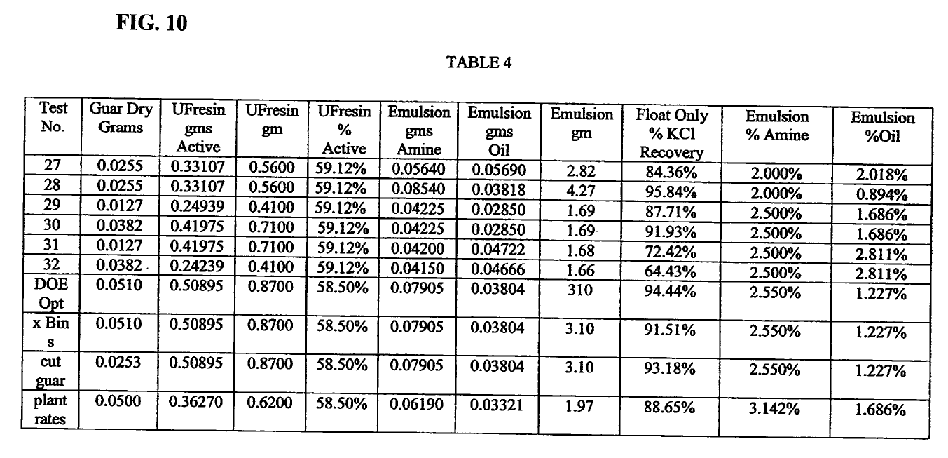

Various laboratory tests were conducted to determine the interaction between reagents and the percent KCl recovery. FIG. 10 shows Table 4, which provides the test results. Laboratory test methods were described above.

Tests 1-5 held the various reagents constant, to determine the percent KCl recovery and variability and reproducibility of those results. The percent KCl recovery ranged between 91.25%-92.42%.

Further, tests 6-9 demonstrate that the percent KCl recovery is not as sensitive to variations in guar gum usage as compared to variations in the amount of urea-formaldehyde resin. A 4-5 percentage point decrease in percent KCl recovery resulted when urea-formaldehyde resin was reduced by approximately half. When no guar was used or varying amounts of guar were used and the amount of the other reagents was unchanged, the % KCl recovery remained high (92%-93%). A comparison in the results of tests 11, 12 and 13 show that an optimal level of amine is required to maintain yields of recovered KCl. A 50% decrease in the amount of amine resulted in an approximately 18 percentage point decrease in percent KCl recovered, one of the largest decreases found in the results chart. Note the similarity in tests 22 and 23, wherein the increase in collector amine resulted in about a 20% increase in percent KCl recovery.

Used at the proper levels, the urea-formaldehyde resin provides for improved recovery levels of potassium chloride without use of a frother or frothing agent in the flotation process by behaving as a frother, reduces the amount of collector reagent required in the flotation process to obtain similar yields, reduces the amount of flocculant required in the clay settling and mud filtration processes, and allows for flotation of coarser ground ore particles. The urea-formaldehyde resin also improves the yields of KCl obtained from the potash ore refining process. The amount of urea-formaldehyde resin used generally may be dependent upon the composition of the potash ore.

A second urea-formaldehyde resin containing cationic groups such as polyethylene polyamine, provides for similar results to the above-noted results. In addition to the above-noted results, this urea-formaldehyde resin allows for reduction of the total amount of urea-formaldehyde resin required to achieve the improved KCl recovery results. Table 3 provides some of the characteristics of the modified urea-formaldehyde resin.

A modified urea-formaldehyde resin provided by Metadynea (associated with JSC Metafrax, both Russian companies), denoted KS-MF, was tested in the laboratory potash ore processing procedure described above. The results showed that a reduced amount of KS-MF provided comparable % recovery of KCl as using larger amounts of urea-formaldehyde resin that was not modified with cationic groups.

The KS-MF product is a urea-formaldehyde polyethylene polyamine, with a urea-formaldehyde weight ratio of about 0.85:1 to 1.25:1. The polyethylene amine (PEPA) ratio to urea ration is about 0.01:1 up to 0.11:1. The molecular weight of the KS-MF ranges from about 120,000 to 250,000. The KS-MF contains 1.1-1.5% free formaldehyde and has a pH of about 7.1-7,5. Further, the % cyclic urea is less than 28; the % mono substituted urea is greater than 5; the % di/tri substituted urea is less than 66; % free formaldehyde ranges from 0-2.

(All of the values in the Table are considered approximate, i.e., prefaced with the term “about.” A person of ordinary skill in the art will recognize that additional ranges within the explicit ranges in the table are contemplated and are within the present disclosure.)

TABLE 3

| Item | Range | Alternative Range |
|---|---|---|
| Weight ratio of | 1:1.12:0.05 to 1:2.7:0.30 | 1:1.13:0.05 to 1:1.17:0.10 |
| urea to | | |
| formaldehyde to | | |
| PEPA | | |
| Type PEPA | DETA, TETA, TEPA, | Heavy PEPA |
| cationic group | Heavy PEPA, PIP, AEP. | |
| | AEEA, | |

PEPA = polyethylene polyamine
PIP = Piperazine
DETA = diethylenetriamine
AEP = Aminoethylpperazine
TETA = triethylenetetramine
AEEA = Aminoethylethanolamine
TEPA = tetraethylenepentamine
Heavy PEPA = mixture of higher molecular weight PEPA's and some lighter ones

Although the invention has been described with reference to preferred embodiments, workers of ordinary skill in the art will recognize that additional, alternative embodiments are contemplated and would not depart from the spirit and scope of the present disclosure.

What is claimed is:

1. A potash ore processing method for the recovery of potassium minerals from potash ore comprising:
conditioning a pulped potash ore, wherein the potash ore comprises a potassium mineral component and a clay component, in a saturated brine solution with an effective amount of brine dispersible urea-formaldehyde resin and frother, wherein the amount of frother used is less than used in an equivalent process which does not include a urea-formaldehyde resin; and
substantially separating the potassium mineral component by way of a floatation process, to recover at least as much potassium mineral as in the equivalent process which does not include urea-formaldehyde resin.

2. The method of claim 1 wherein the potash ore is sized to pass through an 8 mesh screen.

3. The method of claim 1 wherein the potash ore is sized to pass through a 10 mesh screen.

4. The method of claim 1 wherein the conditioning is performed with effectively no frother.

5. The method of claim 1 wherein no more than about 50 wt % frother is used relative to the equivalent process with no urea-formaldehyde resin.

6. The method of claim 1 wherein the amount of brine dispersible urea-formaldehyde resin is at least about 0.003 wt. % of the dry potash ore.

7. The method of claim 1 wherein the amount of brine dispersible urea-formaldehyde resin is at least about 0.006 wt. % of the dry potash ore.

8. The method of claim 1 further comprising conditioning the clay component with flocculent.

9. The method of claim 8 further comprising separating the clay component of the potash ore from the process brine through settling of the clay component and/or the separation of clay from the process brine by way of a solids-liquid separation unit.

10. The method of claim 9 wherein the potential liquid removal rate for separating the clay agglomerates from the brine is increased relative to an equivalent process which does not include urea-formaldehyde resin.

11. The method of claim 1 further comprising adding depressor to the pulped potash ore wherein the amount of depressor added to the pulped potash ore is not more than about 0.005 wt % based upon dry potash ore.

12. The method of claim 1 wherein the pulped ore comprises no more than 0.011 wt % of a collector composition, based upon dry potash ore.

13. The method of claim 12 wherein the pulped ore comprises no more than 0.002 wt. % of amine collector based upon dry potash ore and no more than 0.009 wt. % aromatic oil based upon dry potash ore.

14. The method of claim 1 wherein at least about 85 wt % of the potassium mineral is recovered from the input of potash ore into the floatation step.

15. A potash ore processing method for the recovery of potassium minerals from potash ore comprising:
contacting a pulped potash ore, wherein the potash ore comprises a potassium mineral component and a clay component, with a saturated brine solution with an effective amount of brine dispersible urea-formaldehyde resin;
conditioning the clay component with flocculent, wherein the amount of flocculent used is less than the amount of flocculent used in an equivalent process which does not include a urea-formaldehyde resin, wherein the flocculent initiates agglomeration of the clay; and
substantially separating the potassium mineral component by way of a floatation process to recover at least as much potassium mineral as in the equivalent process which does not include urea-formaldehyde resin.

16. The method of claim 15 wherein the amount of brine dispersible urea-formaldehyde resin is at least about 0.003 wt. % of the dry potash ore.

17. The method of claim 15 further comprising separating the clay component of the potash ore from the process brine through settling of the clay component and/or the separation of clay from the process brine by way of a solids-liquid separation unit.

18. The method of claim 17 wherein the rate of separating the clay component is greater than in an equivalent process that does not include urea-formaldehyde resin.

19. The method of claim 15 wherein at least about 30% less flocculent is used relative to the equivalent process which does not include urea-formaldehyde resin.

20. The method of claim 15 wherein the amount of flocculent is no more than 0.5 wt. % of the dry potash ore.

21. The method of claim 15 wherein the brine dispersible urea-formaldehyde resin is a copolymer of urea-formaldehyde polymer and polyamine.

22. The method of claim 15 wherein at least about 85 wt % of the potassium mineral is recovered from the input of potash ore into the floatation process.

23. A potash ore processing method for the recovery of potassium mineral from potash ore comprising:
conditioning a pulped potash ore, wherein the potash ore comprises a potassium mineral component and a clay component, in a saturated brine solution with an effective amount of brine dispersible urea-formaldehyde resin;
conditioning the clay component with flocculent, wherein clay agglomerates are formed in the brine after addition of the flocculent;
substantially separating the potassium mineral component by way of a floatation process; and
separating the clay component of the potash ore from the brine through settling of the clay component and/or separation of the process brine from the clay by way of a solids-liquid separation unit operation wherein the potential liquid removal rate is increased at least an average of about 10% (volume/hour) as compared to an equivalent process which does not include urea-formaldehyde resin.

24. The method of claim 23 wherein the amount of brine dispersible urea-formaldehyde resin is at least about 0.003 wt. % of the dry potash ore.

25. The method of claim 23 wherein the amount of brine dispersible urea-formaldehyde resin is at least about 0.006 wt. % of the dry potash ore.

26. The method of claim 23 wherein the amount of flocculent is no more than 0.5 wt. % of the dry potash ore.

27. The method of claim 23 wherein the brine dispersible urea-formaldehyde resin is a copolymer of urea-formaldehyde polymer and polyamine.

28. The method of claim 23 wherein the potential liquid removal rate is increased at last an average of about 25% (volume/hour) as compared to an equivalent process which does not include urea-formaldehyde resin.

29. The method of claim 23 wherein at least about 85 wt % of the potassium mineral is recovered from the input of potash ore into the floatation step.
